(19) United States
(12) Patent Application Publication
(10) Pub. No.: US 2021/0214037 A1
(43) Pub. Date: Jul. 15, 2021

(54) Bicycle with Connector Function, Bicycle Connector and Bicycle Cassette

(71) Applicant: VANMOOF B.V., Amsterdam (NL)

(72) Inventor: Ties Jonan Midas Carlier, Amsterdam (NL)

(21) Appl. No.: 17/048,920

(22) PCT Filed: Apr. 17, 2019
(86) PCT No.: PCT/NL2019/050226

§ 371 Date: Oct. 19, 2020

(30) Foreign Application Priority Data
Apr. 17, 2018 (NL) 2020780

(51) Int. Cl. B62K 19/40; B62K 19/06; B62K 19/32; B62M 6/40; B62M 6/90

(52) U.S. Cl. CPC B62K 19/40; B62K 19/06; B62K 19/24; B62M 6/40; B62M 6/90; B62K 19/32

(57) ABSTRACT

The present invention relates to a bicycle with connector function and at least a number of subsystems. The bicycle includes a tube assembly including a frame with mutually fixed tube elements and movable tube elements, such as a steering pin and a handlebar, at least a first bicycle cassette, for holding at least a first of the number of subsystems, such as a bicycle control unit, of the bicycle for providing a respective function to the bicycle. The first bicycle cassette is arrangeable in at least a first tube element of the tube assembly, and includes a first cassette contact, including a number of contact poles, that is connectable with the at least first of the number of subsystems internal in the first bicycle cassette. A bicycle also includes a connector for connecting with the first cassette contact of the first bicycle cassette. The bicycle connector includes a first connector contact, including a number of contact poles, for connecting with the first cassette contact, and at least one output contact for connecting with a respective subsystem. The bicycle connector is arrangeable in the respective first tube element of the tube assembly.

### CROSS-REFERENCE TO RELATED APPLICATIONS

This application is the United States national phase of International Application No. PCT/NL2019/050226 filed Apr. 17, 2019, and claims priority to The Netherlands Patent Application No. 2020780 filed Apr. 17, 2018, the disclosures of which are hereby incorporated by reference in their entirety.

### BACKGROUND OF THE INVENTION

### Field of the Invention

The present invention relates to a bicycle with connector function for mutually connecting of a number of subsystems and for connecting in a simple manner by means of inserting of a bicycle cassette. Furthermore, the present invention relates to a bicycle connector for connecting of the bicycle cassette with at least one of the number of subsystems and/or for connecting of a first bicycle cassette with a second bicycle cassette. Furthermore, the present invention relates to a bicycle cassette for application in the bicycle was connector function and/or for connecting with the bicycle connector.

### Description of Related Art

It is known to arrange a number of parts together in an inner tube in a housing in a top tube of a bicycle, such as described in the international patent application WO 2010/151115. At that time, it was deemed advantageous in and inventive manner to arrange such parts by means of one operation in this top tube.

### SUMMARY OF THE INVENTION

In order to further this concept and further improve assembly and maintenance of a bicycle, the present invention provides a bicycle with connector function and at least a number of subsystems, the bicycle comprising:
a tube assembly comprising a frame with mutually fixed tube elements and movable tube elements, such as a steering pin and a handlebar,
at least a first bicycle cassette, for holding off at least a first of the number of subsystems, such as a bicycle control unit, of the bicycle for providing a respective function to the bicycle, wherein the first bicycle cassette:
   is arrangeable in at least a first tube element of the tube assembly,
   comprises a first cassette contact, comprising a number of contact poles, that is connectable with the at least first of the number of subsystems internal in the first bicycle cassette,
a bicycle connector for connecting with the first cassette contact of the first bicycle cassette, the bicycle connector comprising:
   a first connector contact, comprising a number of contact poles, for connecting with the first cassette contact,
   at least one output contact for connecting with a respective subsystem,
wherein the bicycle connector is arrangeable in the respective first tube element of the tube assembly.

With this, it is an important advantage that at least a part of the subsystems of the bicycle are mutually connectable in a simple manner by means of the connection between a connector contact of the bicycle connector and a cassette contact of the bicycle cassette. The cassette contact is preferably connected with the connector contact as a simple electric plug contact. With this, all contacts are made via one simple operation.

An important advantage is this is that a bicycle that is provided with a relatively large number of subsystems may be produced, assembled or maintained in a simple manner.

According to a first preferred embodiment, the bicycle comprises:
at least a second bicycle cassette, for holding off at least a second of the number of subsystems, such as an accumulator or battery, of the bicycle for providing a respective function to the bicycle, wherein the second bicycle cassette:
   is arrangeable in at least a second tube element of the tube assembly,
   a second cassette contact, comprising a number of contact poles, that intermittently in the second bicycle cassette is coupled connectable with at least a further instance of the number of subsystems,
the bicycle connector for connecting with the first and the second cassette contact of the first bicycle cassette and the second bicycle cassette, comprising:
   a second connector contact, comprising a number of second contact poles for connecting with the second cassette contact,
   a number of pull connectors, such as comprising wires, for connecting of at least a part of the number of first contact poles of the first cassette contact with at least a part of the number of second contact poles of the second connector contact.

By means of such a preferred embodiment, it is preferably possible to provide an electrical connection between 2 tube elements of a bicycle, such as between the top tube at the bottom tube. With this, it is realized that a bicycle cassette in the top tube is connectable with a cassette in the bottom tube by means of a simple connector connection, such as similar to an electrical plug connection.

An especially advantageous variant is the variant in which a central control unit of the bicycle is arrangeable in a top tube cassette as variant of the bicycle cassette arrangeable in the top tube. With this, the top tube cassette and the bottom tube cassette are mutually connectable by means of the bicycle connector having the first cassette contact in the top tube at the second cassette contact in the bottom tube. With placement of the top tube cassette or the bottom tube cassette, the necessary connections between the cassettes and with further subsystems of the bicycle are made directly when the contact poles connect with each other.

Further preferably, the bicycle comprises a pole connector housing for protecting of at least a number of the number of pull connectors, preferably as part of the bicycle connector. With this, the connection between the first connector contact to the second connector contact is protected against damaging or filing, such as during use, during placement thereof or during maintenance of the bicycle.

According to a further preferred embodiment, the bicycle connector comprises a bridge element for mutually connecting of the first connector contact with the second connector contact, preferably for the purpose of providing a mutual orientation. It is advantageous when after placement of the bicycle connector, the contacts are arranged in suitable suitable orientation for making contact with the first and/or the second cassette contact. Furthermore, such a bridge provides a defined shape to a combination of the first connector contact and the second connector contact for the purpose of easy handling thereof. Furthermore, such a bridge provides firmness to the bicycle connector for protection of the pole connectors.

According to a further preferred embodiment, the first connector contact and/or the second connector contact comprises contact poles for the purpose of transferring of a charging current to a battery and/or a drive current to a drive motor of the bicycle. With this, it is for example possible to arrange a charging contact in a different tube element than the tube element in which the accumulator or battery is arranged, while the advantages of a bicycle connector or bicycle with bicycle connector according to the present invention are maintained. The first connector contact and/or the second connector contact further preferably comprise contact poles for the purpose of transferring an information signal or a control signal from a subsystem or to a subsystem. Further preferably, the bicycle comprises a combination of contact poles for the purpose of a charge current and contact poles for the purpose of an information signal or a control signal. Advantages thereof are indicated in the above.

For the purpose of a reliable placement of the cassette, the bicycle connector comprises guide means for guiding and/or centering of the respective connector contact during mutually connecting of the respective cassette contact and connector contact. With for example sliding in of the cassette into a tube element, these guide means are functional with the so-called ‘searching’ of the contacts. Furthermore, the guide means provide a mutual firmness while the bicycle connector and the respective cassette are arranged in a mutual connection, or position of use.

According to a further preferred embodiment, the contacts comprise pin contacts or ball contacts.

The mutual sizing of the bicycle connector and at least a first tube element is further preferably such that the bicycle connector is passable through this tube element.

Further preferably, the bicycle connector is transferable through this first tube element to a coupling or bend between this tube element and a second tube element for arrangement at that is coupling or bend for the purpose of providing of a connector connection between the first tube element and the second tube element by means of the bicycle connector. With this, specifically the connection between two adjacent tube elements is realized.

For the purpose of a connection between the top tube and the bottom tube, further preferably the first cassette contact is functionally arrangeable in the top tube of the bicycle, and the second cassette contact is functionally arrangeable in the bottom tube of the bicycle. With this, it is considered that the mutual arrangement may be embodied in reversed fashion, for instance for arrangement of a battery in the top tube and a control unit in the bottom tube.

For the purpose of a stable fastening, further preferably the bicycle comprises mounting means for mounting of the bicycle connector in a functional position. Such a stable fastening provides advantageously that a connector contact is fixable at a suitable position for receiving of a cassette contact.

For the purpose of mounting in the tube element, the fastening means are arranged such that these are operable from the bottom side and/or the top side of the steering tube. To this end, a screw connection is preferably provided with a screw thread in or at the mounting means, such as at the bridge of the bicycle connector.

Furthermore, the first and the second cassette contact are further preferably each arranged for a respective connection function, or wherein the first and the second cassette contact are identical. Depending on the application, cassettes with identical connectors are applicable or cassettes with 2 different functions, such as one for a control unit and one for a battery are applicable.

Further preferably, a tube element with a bicycle cassette arrangeable therein have a mutual guiding shape such that cassette is only arrangeable in the tube element in an orientation fitting with finding connection between the cassette contact and the connector contact. With this, a suitable orientation between the cassette contact and the connector contact is advantageously achieved.

A further aspect according to the present invention relates to a bicycle connector according to the present invention for a bicycle according to the present invention, comprising:
a first connector contact, comprising a number of contact poles, for connecting with the first cassette contact,
at least one output contact for connecting with a respective subsystem,
wherein the bicycle connector is arrangeable in the respective first tube element of the tube assembly.

Such aspect provides advantages as indicated in relation to the preceding aspect.

According to a first preferred embodiment, such a bicycle connector comprises:
a second connector contact, comprising a number of second contact poles, for connecting with the second cassette contact,
a number of pull connectors, such as comprising wires, for connecting of at least a first of the number of first contact poles of the first cassette contact with at least a part of the number of second contact poles of the second connector contact.

According to a further preferred embodiment, such a bicycle connector comprises a bridge element for mutually connecting of the first connector contact with the second connector contact, preferably for the purpose of providing of a mutual orientation.

A further aspect according to the present invention relates to a bicycle cassette according to the present invention for a bicycle according to the present invention for holding all of at least a first of a number of subsystems, such as a control unit, of the bicycle for providing of a respective function to the bicycle, wherein the first bicycle cassette:
is arrangeable in at least a first tube element of the tube assembly,
comprises a first cassette contact, comprising a number of contact poles, that is connectable with the at least first of the number of subsystems internally in the first bicycle cassette.

A further preferred embodiment relates to such a bicycle cassette, wherein the bicycle cassette:
is arrangeable in at least a second tube element of the tube assembly,
comprises a second cassette contact, comprising a number of contact poles, that is connectable with at least a further of the number of subsystems internally in the second bicycle cassette.

According to a further preferred embodiment, the bicycle cassette comprises a detection assembly for detecting of in ambient air present particles with a size it's more than 20 μm, preferably smaller than 10 μm, preferably smaller than 5 μm, further preferably about 2.5 micrometer or smaller than 2.5 micrometer, which detection assembly is preferably arranged as an underside of the bicycle cassette, further preferably with an air inlet opening and an air outlet opening with substantially therebetween the detection assembly. By means of such a detection assembly, the bicycle cassette or the bicycle comprising the bicycle cassette functions as measurement device for particulate matter for providing of measuring data relating to the presence of particulate matter in the ambient air. Further preferably, the bicycle cassette and/or the control unit thereof comprises means for associating and/or enriching of the metadata with location data and/or time data. An advantage thereof is that such measuring data and augmented measuring data of the collection thereof in the bicycle cassette is transferable for the purpose of further analysis thereof and/or recording thereof in a database, such as on a server, for combining with further information relating to such air pollution or for a further scientific purpose.

According to a further preferred embodiment, the bicycle cassette comprises a microphone opening and a microphone for detecting of ambient sound, further preferably coupled with a control unit arranged in the bicycle cassette or a with the bicycle cassette connected further bicycle cassette.

### BRIEF DESCRIPTION OF THE DRAWINGS

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

FIG. 1 relates to a schematic representation of a first preferred embodiment according to the present invention.

FIG. 2 relates to a representation in perspective view of a preferred embodiment according to the present invention.

FIG. 3 relates to a side view of a preferred embodiment according to FIG. 2.

FIG. 4 relates to a schematic representation of a further preferred embodiment according to the present invention.

FIG. 5 relates to a schematic representation of mounting stages of the first preferred embodiments.

FIG. 6 relates to a schematic representation of mounting stages of the second preferred embodiments.

FIG. 7 relates to 2 representation in perspective view of a further preferred embodiment.

### DESCRIPTION OF THE INVENTION

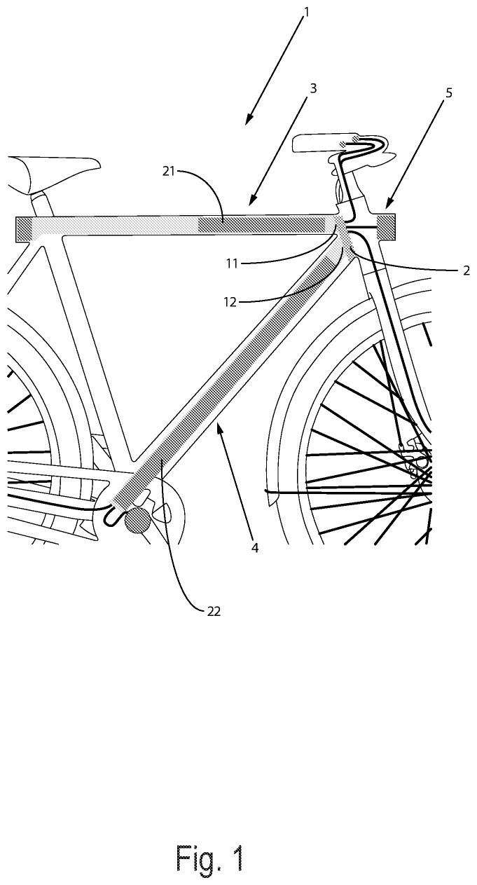

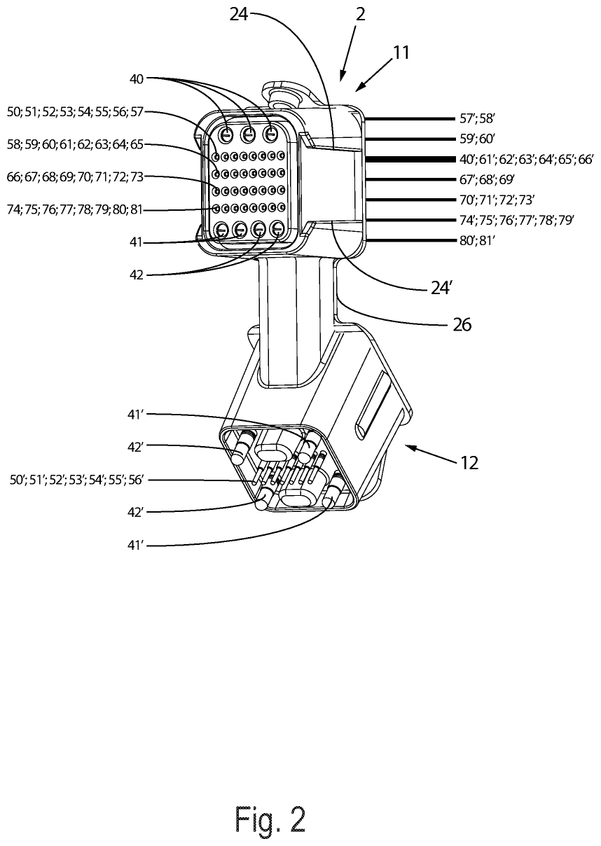

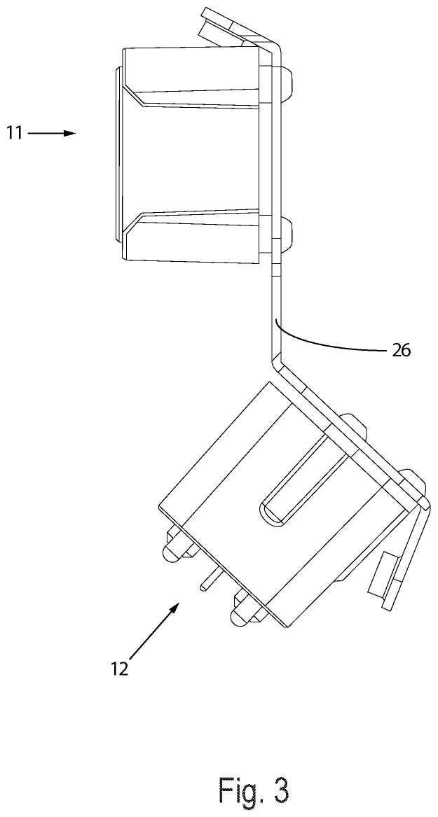

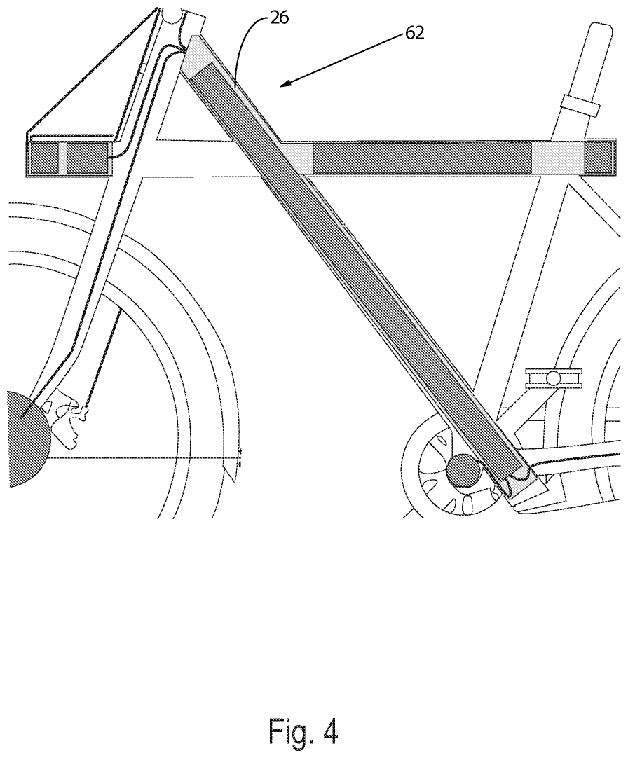

A first preferred embodiment (FIG. 1) according to the present invention relates to a bicycle 1. It comprises a bicycle connector 2 for arrangement in a junction between a top tube 3 and a bottom tube for at the location of the steering pin 5. The bicycle connector 2 (FIG. 2) comprises a first connector contact 11 and a second connector contact 12. The first connector contact 11 serves the purpose of connecting with a cassettes 21 for arrangement thereof in the top tube 3. The second connector contact 12 serves the purpose of connecting with a cassette 22 for arrangement thereof in bottom tube 4.

The top tube cassettes 21 comprises a cassette contact 21′ for connection with connector contact 11. The bottom tube cassettes 22 comprises a cassette contact (not shown) for corresponding connection with the connector contact 12.

The bottom tube cassette comprises a battery or accumulator for driving the bicycle by means of an electrical motor therewith. Furthermore, the bottom tube cassette comprises a battery management system for optimizing charging and discharging of the battery during use thereof and during charging thereof. The bottom tube cassette is an optional cassette according to the present invention.

The top tube cassette 21 comprises a control unit for controlling of or functioning together with several subsystems of the bicycle, such as a drive motor or a sensor therein, lock with a sensor and/or solenoid therein, bell function or horn function, bell button or horn button, and/or a rev counter. The pins of connector contact 11 and connector contact 12 have a function as follows.

Poles 40 provides power to a 3 phase motor. Poles 41 relates to the negative pole of the battery. The poles 42 relate to the positive pole of the battery. The pole 50 relates to the pole for charging of the battery, as well as the poles 51 and 52. Pole 53 relates to a TX pole for communication with the battery. Pole 54 relates to an RX pole for communication with the battery. Pole 55 relates to an earthing pole for the battery. Pole 56 relates to a 5 volt VCC for the battery. The poles 57, 58 connect with the bell button. The poles 59, 60 connected with a boost button for raising the engine power of the drive motor of the bicycle. The poles 61, 62, 63 connected with a hall sensor of the motor. The poles 64, 65 connect with a motor of a further subsystem. The pole 66 connects with a temperature sensor of the motor. The poles 67, 68, 69 are as yet left empty. The poles 70, 71, 72, 73 connect with a bicycle lock, a solenoid and a sensor switch thereof. The poles 74, 75, 76, 77 connect with a hall sensor of a rev counter of the bottom bracket. The poles 78 connect with an earth connection of the rev counter of the bottom bracket. The poles 80, 81 connect with the front light of the bicycle.

With this, examples are indicated of the connections of the poles of the connector contacts. The head end of the top tube cassettes 21 comprises the cassette contact 21′ thereof. The cassette contact 21′ comprises poles or pins in correspondence with poles as described with the connector contact 1 according to FIG. 2. Also the bottom tube cassette comprises poles in correspondence with the poles of the corresponding connector contact.

Connections from the cassette with further subsystems of the bicycle are also provided with via the bicycle connector. Herewith, it is advantageously possible that all or substantially a number of subsystems of the bicycle are connectable with the bicycle cassette in a simple manner. To this end, cables are guided from the bicycle connected to the respective subsystems as indicated in the above.

With this, it becomes possible according to the present invention to easily mount and/or replace a cassette by sliding it into the respective tube until the contacts are in mutual connection or are inserted therein in a correct manner. With this, it is advantageously achieved that all subsystems become connected with the cassette, the subsystems therein and/or the central control of the bicycle in the top tube cassette by means of a simple connection operation. It is just as well provided that the functions of the cassette are applied in reverse manner such that the battery is in the top tube or the control unit in the bottom tube. Furthermore, it is provided that such a bicycle connector is embodied single sidedly for the variant that merely a bottom tube cassette or a top tube cassette is applied in the bicycle. This is for example in case the bicycle is provided with a control unit, but for example not with a drive motor with the thereto belonging battery or accumulator.

The connector is provided with a guide edge 24, 24′ for guiding of ribs 23, 23′ of the head end of the cassette or of the cassette contact. With this, it is achieved that pushing of the cassette such that the poles may contact with each other can only be performed when the mutual orientation is sufficiently accurate. With this, also a ‘seeking’ function is provided for the purpose of correctly inserting of the contacts of the cassette in the context of the bicycle connector and vice versa, depending on the orientation of the male/female connections that are considered reversible.

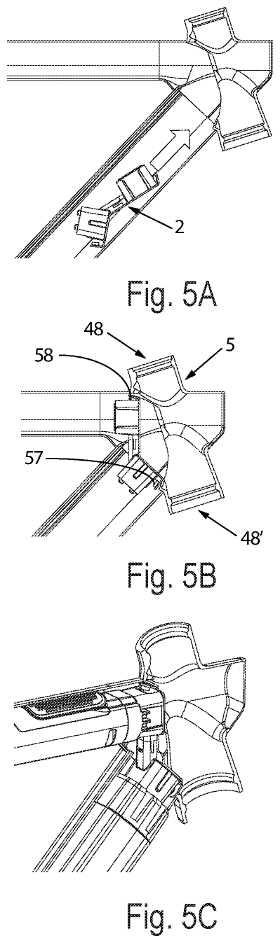

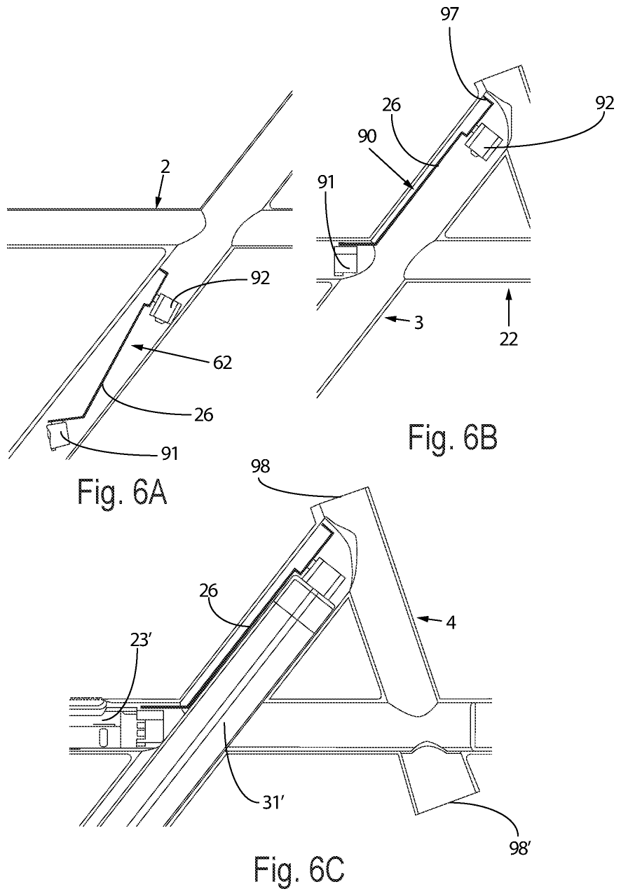

Furthermore, it is shown how to bicycle connector is inserted into the frame (FIG. 5). Bicycle connector is inserted from the bottom side of the bottom tube and moved upwardly until the junction between the bottom tube at the top tube where it is connected by means of screw connections 57 respectively 58. After a simple fastening operation by means of the screw connections the connector is ready for receiving the respective cassette contacts. The screw connections are advantageously realizable by means of the top opening 48 and the bottom opening 48′ of the steering tube 5.

For the purpose of the mutual orientation of the connector contact, a bridge 26 is provided to which the connector contacts are mounted. Furthermore, the bridge is provided with a screw thread for the purpose of screw connections 57, 58.

For the purpose of connecting of the connector contacts with the subsystems outside the top tube cassette and the bottom tube cassette, wires are provided that extend from the respective pulse to the respective subsystems.

An alternative variant of the bicycle connector relates to the bicycle connector for a so-called X frame. In the X frame, the distance between the bottom tube and the top tube, at least the beginning of openings thereof is differently arranged then with the frame as shown in FIG. 1 at 5. To this end, a bicycle connector 62 is provided with corresponding contacts as the bicycle connector tool, but with a different orientation relative to the bridge 26. FIG. 8 shows two preferred embodiments of a cassettes 21′ that is provided with a particulate matter measurement device 101 that is provided with an input opening 102 and an output opening 103 at the bottom side of the cassette 21′. The cassette is furthermore provided with a microphone 100 therefore for providing of a sensor function for ambient noise. Furthermore, a loudspeaker 105 is provided, next to a charge port 106, for feedback of sound signals to the user from the control unit of the bicycle.

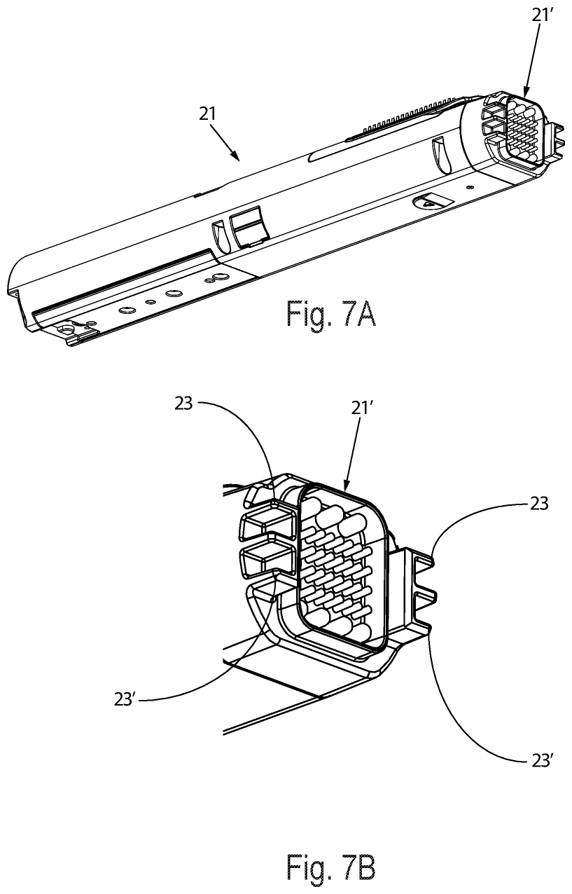

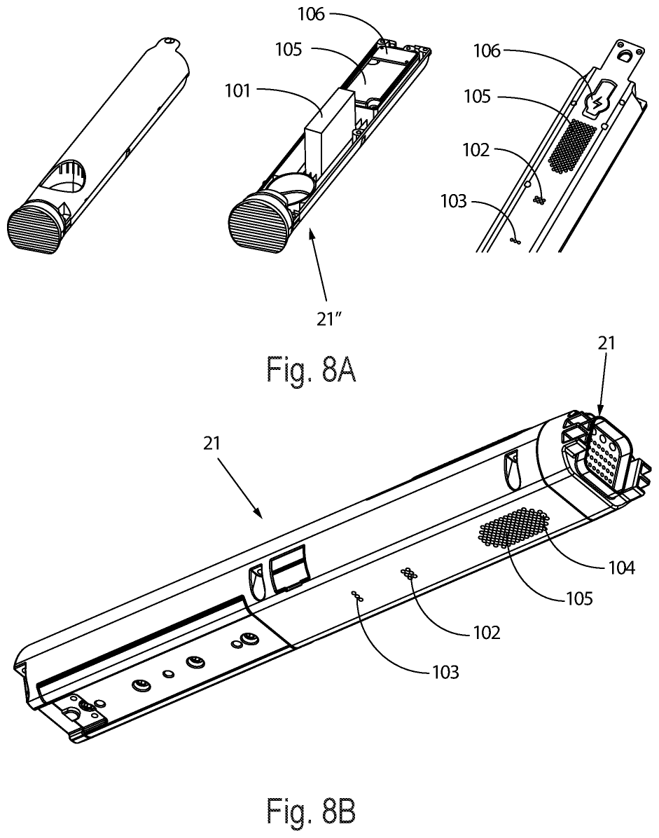

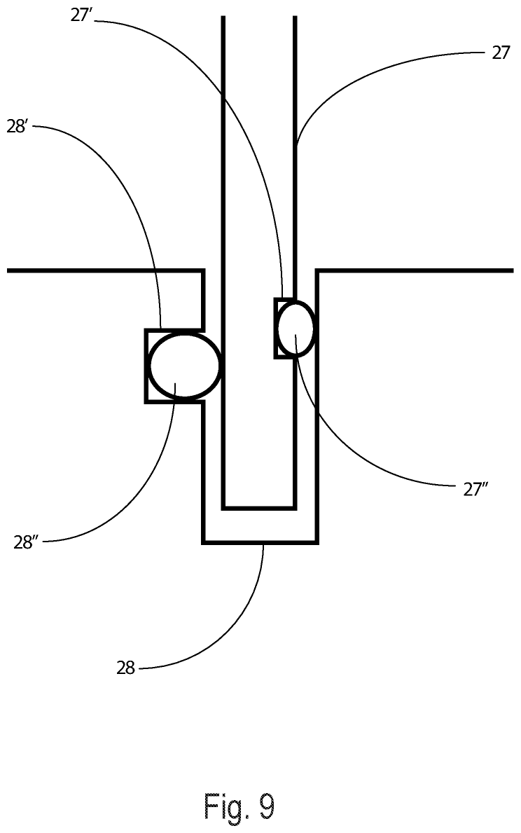

In addition to a head end side sealing of the cassette according to FIG. 7, a single or double sealing according to FIG. 9 is provided to the connector. This sealing functions durably because a wall part 27 of the connector of the cassette is slidable in into a slot 28 of the counter connector of the bicycle connector or vice versa. With this, a ring-shaped water countering member, such as a rubber ring 27″, insertable into a slot 27′ in the wall along which an insertion edge of the connector is insertable. Together with this, or separate from this, a similar ring 28″ is provided in a connector slot 28′ in the insertion edge of the connector for providing of the further sealing by means of this ring.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. A bicycle with connector function and at least a number of subsystems, the bicycle comprising:
a tube assembly comprising a frame with mutually fixed tube elements and movable tube elements, such as a steering pin and a handlebar,
at least a first bicycle cassette, for holding at least a first of the number of subsystems, such as a bicycle control unit, of the bicycle for providing a respective function to the bicycle, wherein the first bicycle cassette:
is arrangeable in at least a first tube element of the tube assembly,
comprises a first cassette contact, comprising a number of contact poles, that is connectable with the at least first of the number of subsystems internal in the first bicycle cassette,
a bicycle connector for connecting with the first cassette contact of the first bicycle cassette, the bicycle connector comprising:
a first connector contact, comprising a number of contact poles, for connecting with the first cassette contact,
at least one output contact for connecting with a respective subsystem,
wherein the bicycle connector is arrangeable in the respective first tube element of the tube assembly.

2. The bicycle according to claim 1, further comprising:
at least a second bicycle cassette, for holding at least a second of the number of subsystems, such as an accumulator or battery, of the bicycle for providing a respective function to the bicycle, wherein the second bicycle cassette:
is arrangeable in at least a second tube element of the tube assembly,
a second cassette contact, comprising a number of contact poles, that intermittently in the second bicycle cassette is coupled connectable with at least a further instance of the number of subsystems,
the bicycle connector for connecting with the first and the second cassette contact of the first bicycle cassette and the second bicycle cassette, comprising:
a second connector contact, comprising a number of second contact poles for connecting with the second cassette contact,
a number of pull connectors, such as comprising wires, for connecting at least a part of the number of first contact poles of the first cassette contact with at least a part of the number of second contact poles of the second connector contact.

3. The bicycle according to claim 2, further comprising a pole connector housing for protecting at least a number of the number of pull connectors, preferably as part of the bicycle connector.

4. The bicycle according to claim 2, wherein the bicycle connector comprises a bridge element for mutually connecting the first connector contact with the second connector contact, preferably for the purpose of providing a mutual orientation.

5. The bicycle according to claim 1, wherein the first connector contact and/or the second connector contact comprises contact poles for the purpose of transferring a charging current to a battery and/or a drive current to a drive motor of the bicycle.

6. The bicycle according to claim 1, wherein the first connector contact and/or the second connector contact comprises contact poles for the purpose of transferring an information signal or a control signal from a subsystem or to a subsystem.

7. The bicycle according to claim 5, further comprising a combination of contact poles for the purpose of a charge current and contact poles for the purpose of an information signal or a control signal.

8. The bicycle according to claim 1, wherein the bicycle connector comprises guiding means for guiding and/or centering of the respective connector contact during mutually connecting of the respective cassette contact and connector contact.

9. The bicycle according to claim 1, wherein the complex comprises pin contacts or ball contacts.

10. The bicycle according to claim 1, wherein the mutual sizing of the bicycle connector and at least a first tube element are such that the bicycle connector is may be passed through this tube element.

11. The bicycle according to claim 10, wherein the bicycle connector may be passed through this first tube element to a coupling or bend between this tube element and a second tube element for arrangement at this coupling or bend for the purpose of providing of a connector connection between the first tube element and the second tube element by means of the bicycle connector.

12. The bicycle according to claim 1, wherein the first cassette contact is functionally arrangeable in the top tube of the bicycle, and wherein the second cassette contact is functionally arrangeable in the bottom tube of the bicycle.

13. The bicycle according to claim 1, further comprising mounting means for mounting of the bicycle connector in a functional position.

14. The bicycle according to claim 13, wherein the mounting means are arranged such that these are operable from the bottom side and/or the top side of the steering tube.

15. The bicycle according to claim 1, wherein the first and the second cassette contact are each arranged for a respective connection function, or wherein the first and the second cassette contact are identical.

16. The bicycle according to claim 1, wherein a tube element with therein arrangeable bicycle cassette have a mutual guiding shape such that the cassette is only arrangeable in the tube element in an orientation fitting with finding connection between the cassette contact at the connector contact.

17. The bicycle connector according to a bicycle according to claim 1, comprising:
a first connector contact, comprising a number of contact poles, for connecting with the first cassette contact,
at least one output contact for connecting with a respective subsystem,
wherein the bicycle connector is arrangeable in the respective first tube element of the tube assembly.

18. The bicycle connector according to claim 17, further comprising:
a second connector contact, comprising a number of second contact poles, for connecting with the second cassette contact,
a number of pull connectors, such as comprising wires, for connecting of at least a first of the number of first contact poles of the first cassette contact with at least a part of the number of second contact poles of the second connector contact.

19. The bicycle connector according to claim 17, further comprising a bridge element for mutually connecting of the first connector contact with the second connector contact, preferably for the purpose of providing of a mutual orientation.

20. A bicycle cassette for holding at least a first of a number of subsystems, such as a control unit, the bicycle for providing of a respective function to the bicycle, wherein the first bicycle cassette:
is arrangeable in at least a first tube element of the tube assembly,
comprises a first cassette contact, comprising a number of contact poles, that is connectable with the at least first of the number of subsystems internally in the first bicycle cassette.

21. The bicycle cassette according to claim 20, wherein the bicycle cassette:
is arrangeable in at least a second tube element of the tube assembly,
comprises a second cassette contact, comprising a number of contact poles, that is connectable with at least a further of the number of subsystems internally in the second bicycle cassette.

22. The bicycle cassette according to claim 20, further comprising a detection assembly for detecting in ambient air present particles with a size more than 20 μm, preferably smaller than 10 μm, preferably smaller than 5 μm, further preferably about 2.5 micrometer or smaller than 2.5 micrometer, which detection assembly is preferably arranged as an underside of the bicycle cassette, further preferably with an air inlet opening and an air outlet opening with substantially therebetween the detection assembly.

23. The bicycle cassette according to claim 22, further comprising a microphone opening and a microphone for detecting ambient sound, further preferably coupled with a control unit arranged in the bicycle cassette or a with the bicycle cassette connected further bicycle cassette.
